(19) United States
(12) Patent Application Publication
(10) Pub. No.: US 2007/0081183 A1
(43) Pub. Date: Apr. 12, 2007

(54) Printing apparatus consumable data communication

(76) Inventors: Earl L. Fugate, Lexington, KY (US); Jason K. Young, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/247,030

(22) Filed: Oct. 10, 2005

(51) Int. Cl. G06K 15/00

(52) U.S. Cl. 358/1.14

(57) ABSTRACT

Methods for communicating data with a circuit associated with a consumable of a printing apparatus, wherein a signal used to communicate data comprises one of at least two states at an object associated with the signal. For example, one method involves receiving N signals and indicating a state on a signal S that uniquely corresponds to an ordered combination of the states corresponding to M of the objects associated with each of the N signals. At least one of M and N are greater than one, and a circuit associated with a consumable of a printing apparatus can receive the signal S and decode the state of the signal S to determine the ordered combination of the states corresponding to the M of the objects associated with each of the N signals. Also disclosed are consumables of a printing apparatus having a circuit associated with the consumable and data signals associated with the same and related embodiments.

### TECHNICAL FIELD

The present invention relates to methods for communicating data between printing apparatus and their consumables, and more specifically, in one embodiment, between a printing apparatus and a circuit associated with a printhead configured to operate in the printing apparatus.

### BACKGROUND OF THE INVENTION

A number is an abstract entity often used to describe a quantity. Numbers are often represented by numerals, wherein a numeral system defines how a symbol or group of symbols are used to represent a number.

In a positional base-b numeral system (with b a positive natural number known as the radix), for example, b basic symbols (sometimes referred to as “digits”) corresponding to the first b natural numbers (including zero) are used to represent a number, wherein the number is determined by the relative positioning of the digit(s) in the numeral. For example, a number can be expressed by the digits α₁α₂α₃ . . . αₖ₊ₗ, in order, where b is the base and the number is equal to α₁b^{k}+α₂b^{k-1}α₃b^{k-2} +. . . +αₖ₊₁b⁰.

In the decimal system (base 10), the digits are 0, 1, 2, 3, 4, 5, 6, 7 8, and 9. In this regard, the numeral “127” can be used to uniquely represent the number equal to (1×10²)+(2×10¹)+(7×10⁰). Meanwhile, in the binary system (base 2), the two digits are 0 and 1 (a binary digit is often referred to as a “bit”). Accordingly, in the binary system, the numeral “1111111” would need to be used to represent the same number as the numeral “127” in the decimal system (i.e., (1×2⁶)+(1×2⁵)+(1×2⁴)+(1×2³)+(1×2²)+(×2¹)+(1×2⁰)=(1×10²)+(2×10¹)+(7×10⁰)).

Data used in and with most modem computing and/or logic devices, such as personal computers and their peripherals, such as stand-alone inkjet printers, is often represented as a numeral, such as a binary numeral (e.g., “0011”). The number of digits in the numeral representation typically corresponds to a minimum number of elements that must be received by that which will process the data (e.g., logic) in order to process the data as designed. For example, in a “8-bit” system, the receiving logic is designed with the expectation that data will be passed to it in increments of at least 8 elements (e.g., a respective state of a signal upon each of 8 rising edges of a clock signal).

Such data is often transmitted by passing a signal comprising an ordered sequence of voltages, wherein the level of the voltage at a given instant in time is considered to be the state of the signal at that instant of time. That which receives the signal may process, store, and/or transmit the data. In processing the data, the response of an electric circuit that receives the signal is dependent on a received level and/or a sequence of received levels of the voltage. In some cases, this type of communication between devices and/or components of a device is generically referred to as “digital communication.”

Typically, to avoid being affected by voltage drift and/or noise, amongst other reasons, it is desirable to use only two voltage levels: one near to zero volts and one at a higher level depending on the supply voltage in use. In such a case, the level of a voltage at a given instant in time, and therefore the state of the signal, can be represented by a bit (e.g., either a “0” or a “1”), wherein a sequence of voltage levels over a period of time (e.g., representing a sequence of states of the signal over that period of time) can be represented by an ordered sequence of bits. Vice versa, data in the form of an ordered sequence of bits (or other digits) can be represented by a signal comprising a corresponding sequence of voltage levels over a period of time.

Ink jet printing is a conventional technique by which printing is accomplished without contact between the printing apparatus and the substrate, or medium, on which the desired print characters are deposited. Such printing is accomplished by ejecting ink via an ink jet ejection circuit, such as one on a chip affixed to a printhead of the printing apparatus. Ink jet ejection circuits include, for example, circuits which utilize pressurized nozzles, piezo-electric elements and/or resistive heater elements for vapor phase droplet formation.

Typical printing operations require ink to be ejected from particular orifices (sometimes referred to as “nozzles”) at particular points in time. To accomplish this, data signals, typically in the form of multiple sequences of voltage levels on multiple communication lines are transmitted in accordance with particular timing constraints. For example, in one conventional embodiment, one signal may be used to transmit “address” data, which may correspond to a 32-bit binary numeral. Meanwhile, another signal may be used to transmit “primitive” data, which may also correspond to a 32-bit binary numeral. The ink ejection chip will then respond to this address and primitive data, amongst other data, to selectively eject ink from a specific location (e.g., a specific nozzle in communication with a specific actuator corresponding to that address and primitive).

Such data is typically clocked into a printhead chip within a predefined range of time (sometimes referred to as an address window). In order to increase print frequencies, such as achieving a print frequency of 24 kHz, the address window needs to correspondingly decrease in time. As such, the frequency at which the data is clocked into the chip must be increased to ensure the data is delivered to the printhead chip fast enough for satisfactory printing. In addition, data transmission to the printhead chip typically requires multiple signals which, in turn, leads to multiple bond pads on the chip (as well as, for example, pads of any tab circuits and/or any leads to a flex cable, etc that may be used in the system). As more complex and faster printing apparatus are developed, there is a need for a data communication method to allow for sending data to a chip associated with a printhead, such as one that can minimize, for example, the number of bond pads and leads to the printhead chip. Accordingly, a method of transmitting data to a chip is desired.

### SUMMARY OF THE INVENTION

One aspect of the present invention is a method for communicating data with a circuit associated with a consumable of a printing apparatus, wherein a signal used to communicate data comprises one of at least two states at an object associated with the signal. The method comprises receiving N signals and indicating a state on a signal S that uniquely corresponds to an ordered combination of the states corresponding to M of the objects associated with each of the N signals. At least one of M and N are greater than one. A circuit associated with a consumable of a printing apparatus can receive the signal S and decode the state of the signal S to determine the ordered combination of the states corresponding to the M of the objects associated with each of the N signals.

Another aspect of the present invention is a consumable of a printing apparatus. A circuit associated with the consumable is configured to: receive a signal S that includes indications of states corresponding to objects associated with the signal S, wherein each of the states indicated on the signal S uniquely corresponds to an ordered combination of states of each of N signals at each of M objects associated with the N signals, wherein at least one of N and M are greater than one S; and decode a state of the signal S to determine the ordered combination of the states of each of the N signals corresponding to each of the M objects.

Yet another aspect of the present invention is a propagated data signal transmitted via a propagation medium. The data signal comprises indications of states corresponding to objects associated with the data signal. Each of the states indicated on the data signal uniquely corresponds to what would have been an ordered combination of states of each of N signals at each of M objects associated with the N signals, wherein at least one of N and M are greater than one. A circuit associated with a consumable of a printing apparatus can act on the data signal to effectively decode a state of the data signal to determine the ordered combination of the states of each of the N signals corresponding to each of the M objects.

These and additional advantages will be apparent in view of the detailed description.

### BRIEF DESCRIPTION OF THE DRAWINGS

While the specification concludes with claims particularly pointing out and distinctly claiming the present invention, it is believed the same will be better understood from the following description taken in conjunction with the accompanying drawings in which:

FIG. 1 is a conceptual diagram of the interrelationship between N signals and an S signal, in accordance with an embodiment of the present invention;

FIG. 2 illustrates exemplary signals which may be acted upon by an exemplary embodiment of the present invention;

FIG. 3 illustrates an exemplary signal transformation corresponding to an exemplary embodiment of the present invention;

FIG. 4 illustrates another exemplary signal transformation corresponding to an exemplary embodiment of the present invention;

FIG. 5 illustrates yet another exemplary signal transformation corresponding to an exemplary embodiment of the present invention; and

FIG. 6 illustrates an exemplary circuit configuration for another exemplary signal transformation corresponding to an exemplary embodiment of the present invention.

The embodiments set forth in the drawings are illustrative in nature and not intended to be limiting of the invention defined by the claims. Moreover, individual features of the drawings and the invention will be more fully apparent and understood in view of the detailed description.

### DETAILED DESCRIPTION OF THE EXEMPLARY EMBODIMENTS OF THE INVENTION

Reference will now be made in detail to various embodiments which are illustrated in the accompanying drawings, wherein like numerals indicate similar elements throughout the views.

One embodiment of the present invention involves a circuit associated with a consumable of a printing apparatus, such as a printhead. In such a system, it is desired for the circuit to receive data. Conventionally, the data might be transmitted in the form of N signals, each of the N signals being capable of having one of at least two states at an object associated with the signal (e.g., an instant in time at which a potential change in state on the signal may be determined, such as upon a rising edge of a clock signal). In contrast, in an exemplary embodiment of the present invention, a signal S is produced that is capable of having one of a plurality of states at an object associated with the signal S, wherein a state of the signal S at the object uniquely corresponds to an ordered combination of the states at M of the objects in each of the N signals. Although it is contemplated that an embodiment of the invention can be utilized with multiple signals (i.e., where N is greater than one), an embodiment of the invention can also be applied in scenarios involving only one signal (i.e., where N=one).

According to one exemplary embodiment of the present invention, a circuit associated with a printhead, such as one comprising an ink ejection circuit, can receive and decode a state of the signal S to produce (including reproduce) an ordered combination of the states at M of the objects in each of the N signals. For example, the circuit can produce (or reproduce) each of the N signals as they would have been conventionally transmitted. Although some embodiments of the invention involve scenarios where a signal S is generated by a controller associated with a printing apparatus, in at least one exemplary embodiment, the N signals are produced by a controller associated with the printing apparatus (e.g., as might have been done conventionally) and received at a summation circuit also associated with the printing apparatus.

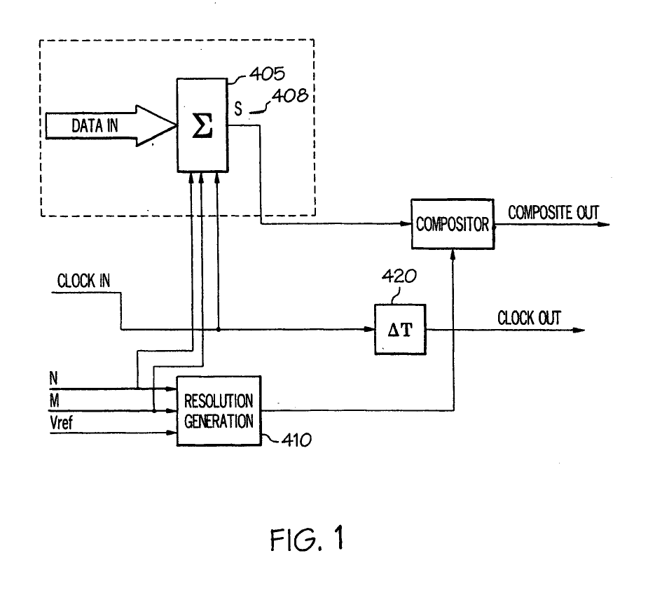

A conceptual diagram of how an embodiment of the invention might operate is shown in FIG. 1. It is important to note that this diagram is not necessarily intended to represent how the invention might be implemented in a circuit, but is instead provided to aid in understanding concepts associated with various embodiments of the present invention (especially with how it relates to how data may have been conventionally communicated). For example, one embodiment of the invention might involve systems where a signal S is generated instead of the N signals, while other embodiments might involve converting N signals into a signal S. In the case of the later example, logic might be implemented on a printed circuit board associated with a printing apparatus that is capable of transforming the N signals into a signal S, such that the relationship between the signals is in general agreement with the concept illustrated in FIG. 1. Moreover, in some embodiments, dynamic approaches might be taken, such as where a circuit can accommodate M and/or N as being variables, while in other approaches the values of M and/or N might be static (e.g., logic has been hardwired or coded for a particular value of M and/or N). Accordingly, as can be understood by one of ordinary skill in the art, circuit implementations of embodiments of the invention may vary considerably from the “devices” and signal flow depicted in the conceptual diagram illustrated in FIG. 1.

Working with the conceptual diagram of FIG. 1, from a conceptual standpoint, one embodiment of the invention seeks to transform the N signals (which may or may not comprise all of the data signals) into the signal S by establishing how different combinations of states in the N signals should be weighed. For example, a unique weighting factor can be assigned (either dynamically, such as through the application of logic, or as programmed into the summation circuit) for each of the M objects in each of the N signals. For example, although other weighting factors might be used, the weighting factor for a particular object Mx of a particular signal Ny (where x={M, . . . , 1}) and y={1, . . . , N}) could be:
w_{f(x,y)}=b^{NMx-Ny},
where b is equal to the number of different states a signal can have at an object Mₓ. In one possible implementation, where there would conventionally be four signals used to transmit data (i.e., N=4), a summation block 405 (or, in other embodiments, for example, a controller) could produce a single signal S 408 to transmit the data (or portions of the data). In at least one embodiment, each of the four signals can be associated with a unique weighting factor (for purposes of this example, different ones in the sequence of objects associated with a signal are not given unique weighting factors—i.e., conceptually, M=one). If the signals are comprised of one of only two possible states at one of a sequence of objects (e.g., the signals are binary digital signals), b can be given a value of 2. Accordingly, in one such conceptual embodiment, the following may comprise the weighting factors:
w_{f(1,1)}=2⁽⁴⁾⁽¹⁾⁻¹=8
w_{f(1,2)}=2⁽⁴⁾⁽¹⁾⁻²=4
w_{f(1,3)}=2⁽⁴⁾⁽¹⁾⁻³=2
w_{f(1,4)}=2⁽⁴⁾⁽¹⁾⁻⁴=1

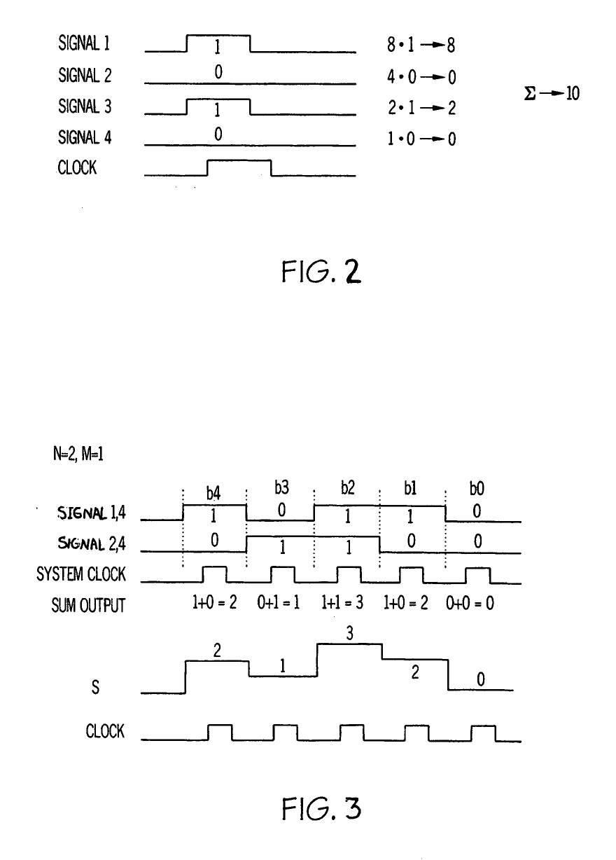

Depending on the state of a signal at an object, a corresponding weighting value can also be assigned, such as in the manner of:
w_{v(x,y)}=a_{x,y}w_{f(x,y)},
where a_{x,y} is equal to a value representative of the state of signal N_{y} at object Mₓ. For example, in an embodiment in which a signal N can have only one of two different states at object Mₓ, a_{x,y} could be given the value of either 0 or 1 (although it is contemplated that other values could be used as well). In the timing diagram shown in FIG. 2, for example, the following values could be assigned for a_{x,y} for the states of Signals 1-4 at the time of the rising edge of the clock signal, Clock:
a_{1,1}=1
a_{1,2}=0
a_{1,3}=1
a_{1,4}=0
In such a case, the following may comprise the weighted values w_{v(x,y)}:
w_{v(1,1)}=1*8=8
w_{v(1,2)}=0*4=0
w_{v(1,3)}=1*2=2
w_{v(1,4)}=0*1=0,
where the sum of the weighting values wv uniquely corresponds to the combination of states (at an object M₁—e.g., the rising edge of Clock) as depicted in FIG. 2 is equal to 10.

In an exemplary embodiment of the present invention, to indicate the unique combination of states represented in FIG. 2 at the rising edge of the signal Clock, the summation circuit or controller, for example, could cause a signal S to have a state that uniquely corresponds to the same. For example, S might be capable of being placed in b^{NM} different states. In the example being currently discussed, where b=2, N=4, and M=1, that means that S might be capable of being placed in 2⁴, or 16, different states (e.g., 16 different voltage levels). In further discussing the current working example, for the combination of states shown in FIG. 2, at the rising edge of the signal Clock, S might be placed into a state that corresponds to the tenth (the sum of the corresponding weighting values) of the sixteen different states. A similar embodiment is depicted in FIG. 3. (in this case, N=2 and M=1), but illustrates succeeding events on the N signals and the corresponding changes in the state of signal S

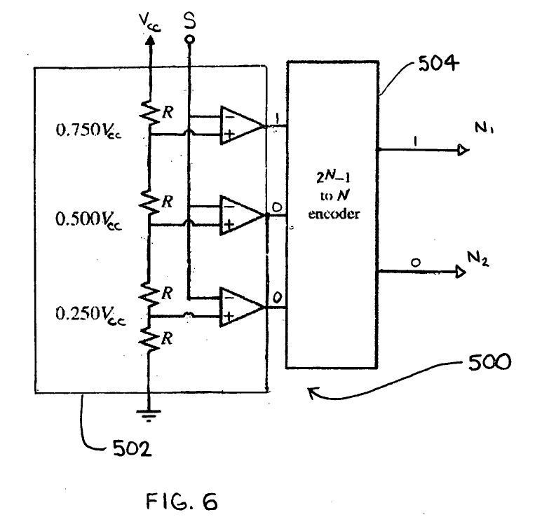

The signal S could therefore be transmitted to, for example, a circuit associated with a consumable of a printing apparatus, wherein the circuit might decode the state of signal S to determine what the ordered combination of states would have been in the N signals. For example, as shown in FIG. 6, such a circuit 500 might include logic 502 for coding a signal S into a 2^{N-1} bit digital code. In the illustrative example, signal S is shown in a state represented by a voltage of V_{cc}/3 (which may be representative of a state on S such as that illustrated in FIG. 3 at object b4). As shown in this exemplary embodiment, at such a state, logic 502 codes the signal S into a 3-bit code (100). As can be understood by one of ordinary skill in the art, circuit 500 might also have logic 504 that receives such a code and codes it into a N bit code, where each bit might be represented in parallel on a separate one of N_{y} signal lines (in the illustrative example, signal lines N₁, and N₂). An exemplary truth table is shown below.

| S state | | State of | State of |
|---|---|---|---|
| number | Code from logic 502 | N₁ | N₂ |
| 0 | 111 | 0 | 0 |
| 1 | 110 | 0 | 1 |
| 2 | 100 | 1 | 0 |
| 3 | 000 | 1 | 1 |

In this manner, the circuit might reproduce the N signals to pass the data to logic, or it may simply act on the data directly.

Conceptually speaking, in one exemplary embodiment, the amplitude of signal S might be constrained by, for example, the operating voltage of the circuit (e.g., what rail it is tied to). Accordingly, the states on the signal S may be represented by discrete voltage levels, the separation between which might be determined in accordance with the conceptual diagram illustrated in FIG. 1. For example, for signal S this separation might be represented by a resolution voltage. In an exemplary embodiment of the invention, the resolution voltage could be determined in accordance with the following equation:
Vres=Vref/(b^{NM}−1),
wherein Vref can be the maximum voltage at which the designer is willing to operate the logic that will interpret the data (e.g., 5 volts or 3.3 V). As can be appreciated by one of ordinary skill in the art by looking at FIG. 1, should an embodiment of the invention be implemented in such a way to allow for a variable M and/or N, for example, such an equation could be implemented in logic corresponding to a resolution generator 410.

As shown in FIG. 1, in some embodiments, such as one in which N signals are produced by a controller associated with a printing apparatus, and the S signal is produced at the printing apparatus, such as for transmission to a circuit on a printhead that is selectively and removably installed in the printing apparatus, the operations required by the summation operation may delay signal propagation in comparison to what might have occurred in the absence of the summation circuit. Accordingly, in such an embodiment, compensation could be included, such as conceptually indicated by block 420 in the conceptual diagram of FIG. 1.

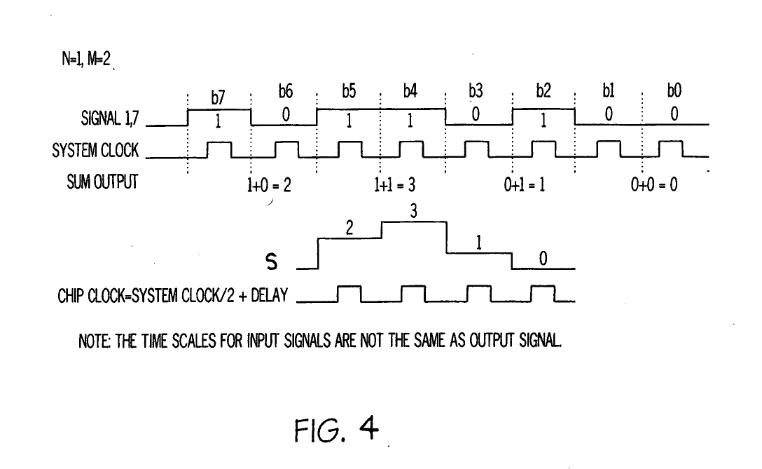

In the previous working examples, a state on signal S corresponded to the states on the N signals (N=4 and N=2) at one object (M=1). Embodiments of the present invention may also be directed at creating a state on signal S that corresponds to the states at multiple objects (M>1) associated with one signal (N=1), and/or at creating a state on signal S that corresponds to the states at multiple objects (M>1) associated with multiple signals (N>1). For example, by reference to FIG. 4, the present invention could be applied to transform and/or replace one signal (i.e., N=1) by indicating a state on signal S that corresponds to an ordered combination of states at M objects (in the illustrated example, M=2). As depicted, a first object (e.g., b7) might be weighted in accordance with a weighting factor=w_{f(2,1)}=2⁽²⁾⁽¹⁾⁻¹=2, while the second object (e.g., b6) might be weighted in accordance with a weighting factor w_{f(1,1)}=2⁽¹⁾⁽¹⁾⁻¹=1. Assuming a={0,1}, as discussed in the previous examples, the weighted value of the signal 1 at each of the M objects can be determined in accordance with the following equations:
w_{v(2,1)}=1*2=2
w_{v(1,1)}=0*1=0,
with the weighted sum of the same being=2. The succeeding third and fourth objects, fifth and sixth objects, and seventh and eighth objects can be acted upon in the same manner, wherein the respective weighted sums are {2, 3, 1, 0}. According to one embodiment of the invention, a corresponding S signal might have one of four states at an object. In the illustrated example, a state of 2 (which might be a particular voltage level on the signal) is produced on signal S to correspond to the noted states of signal 1 at the first and second objects, a state of 3 is produced on signal S to correspond to the noted states of signal 1 at the third and fourth objects, etc. For example, in a 3.3-volt system, each of the states on signal S might be represented by increments of 1.1 V (e.g., state 0 on signal S may be represented by a substantially zero voltage, state 1 may be represented by a voltage level of substantially 1.1 V, state 2 may be represented by a voltage level of substantially 2.2 V, and state 3 may be represented by a voltage level of substantially 3.3 V).

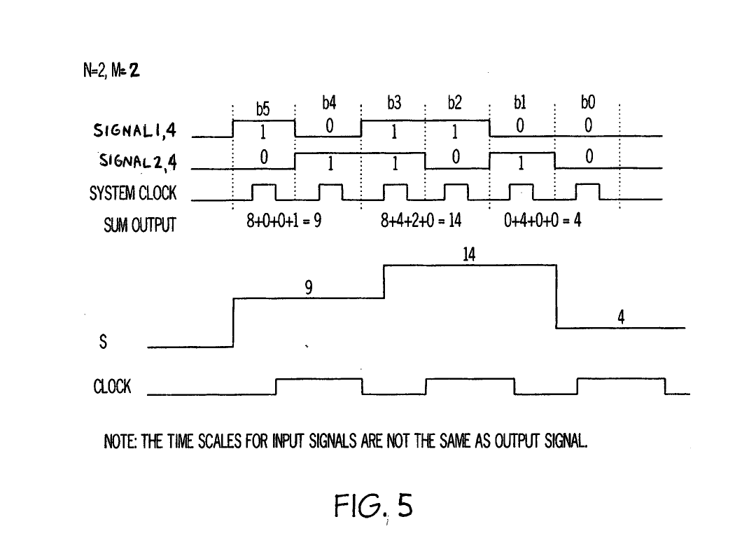

Still further, embodiments of the invention could be directed at transforming and/or replacing multiple signals in an implementation where M is greater than 1, as illustrated by example in FIG. 5. In one such embodiment, a collection of states for a number of objects could be weighted by assigning a weighted value for each state at each object in the N signals (in this case, N=2). In this example, the weighted values at each of the first (M1=b5) and second objects (M2 =b4) in signals 1 and 2 might be:
w_{v(2,1)}=1*2⁽²⁾⁽²⁾⁻¹=8
w_{v(1,1)}=0*2⁽²⁾⁽²⁾⁻²=0
w_{v(2,2)}=0*2⁽²⁾⁽²⁾⁻²=0
w_{v(2,1)}=1*2⁽²⁾⁽²⁾⁻¹=1,
wherein the weighted sum is equal to 9. In such a case, signal S may have 16 different states, wherein for the noted objects and signals, state number 9 might be produced on signal S (e.g., a voltage level of substantially 3.0 V in a 5V system).

The foregoing description of the various embodiments and principles of the invention has been presented for the purpose of illustration and description. It is not intended to be exhaustive or to limit the inventions to the precise forms disclosed. Many alternatives, modifications and variations will be apparent to those skilled in the art. Moreover, although multiple inventive aspects have been presented, such aspects need not be utilized in combination, and various combinations of inventive aspects are possible in light of the various embodiments provided above. Accordingly, the above description is intended to embrace all possible alternatives, modifications, combinations, and variations that have been discussed or suggested herein, as well as all others that fall within the principals, spirit and broad scope of the invention as defined by the claims.

We claim:

1. A method for communicating data with a circuit associated with a consumable of a printing apparatus, wherein a signal used to communicate data comprises one of at least two states at an object associated with the signal, the method comprising:
receiving N signals;
indicating a state on a signal S that uniquely corresponds to an ordered combination of the states corresponding to M of the objects associated with each of the N signals, wherein at least one of M and N are greater than one,
wherein a circuit associated with a consumable of a printing apparatus can receive the signal S and decode the state of the signal S to determine the ordered combination of the states corresponding to the M of the objects associated with each of the N signals.

2. The method of claim 1, wherein N is a number greater than one and M is equal to one.

3. The method of claim 1, wherein N is equal to one and M is greater than one.

4. The method of claim 1, wherein N and M are greater than one.

5. The method of claim 1, wherein the object associated with the signal is a time associated with the signal.

6. The method of claim 5, wherein the time associated with the signal that comprises the object is a time at which there is an edge of a clock signal.

7. A consumable of a printing apparatus, wherein a circuit associated with the consumable is configured to:
receive a signal S that includes indications of states corresponding to objects associated with the signal S, wherein each of the states indicated on the signal S uniquely corresponds to an ordered combination of states of each of N signals at each of M objects associated with the N signals, wherein at least one of N and M are greater than one S; and
decode a state of the signal S to determine the ordered combination of the states of each of the N signals corresponding to each of the M objects.

8. The consumable of claim 7, wherein N is a number greater than one and M is equal to one.

9. The consumable of claim 7, wherein N is equal to one and M is greater than one.

10. The consumable of claim 7, wherein N and M are greater than one.

11. The consumable of claim 7, wherein the object associated with the signal is a time associated with the signal.

12. The consumable of claim 11, wherein the time associated with the signal that comprises the object is a time at which there is an edge of a clock signal.

13. A propagated data signal transmitted via a propagation medium, the data signal comprising indications of states corresponding to objects associated with the data signal, wherein each of the states indicated on the data signal uniquely corresponds to what would have been an ordered combination of states of each of N signals at each of M objects associated with the N signals, wherein at least one of N and M are greater than one; and wherein a circuit associated with a consumable of a printing apparatus can act on the data signal to effectively decode a state of the data signal to determine the ordered combination of the states of each of the N signals corresponding to each of the M objects.

14. The propagated data signal of claim 13, wherein N is a number greater than one and M is equal to one.

15. The propagated data signal of claim 13, wherein N is equal to one and M is greater than one.

16. The propagated data signal of claim 13, wherein N and M are greater than one.

17. The propagated data signal of claim 13, wherein the object associated with the signal is a time associated with the signal.

18. The propagated data signal of claim 17, wherein the time associated with the signal that comprises the object is a time at which there is an edge of a clock signal.

19. The propagated data signal of claim 13, wherein the N signals are generated by a controller associated with the printing apparatus and are reproduced by the circuit associated with the consumable.

20. The propagated data signal of claim 13, wherein the N signals are not physically generated.
